(19) United States
(12) Patent Application Publication
(10) Pub. No.: US 2026/0037723 A1
(43) Pub. Date: Feb. 5, 2026

(54) RECOMMENDING TARGETED INFORMATION

(71) Applicant: INTUIT INC., Mountain View, CA (US)

(72) Inventors: Shon MENDELSON, Tel Aviv (IL); Yaakov TAYEB, Tzur Hadassa (IL); Sigalit BECHLER, Bney Zion (IL); Kaaleb EDERY, Ramat Gan (IL)

(21) Appl. No.: 18/789,845

(22) Filed: Jul. 31, 2024

(51) Int. Cl. G06F 40/20

(52) U.S. Cl. CPC G06F 40/20

(57) ABSTRACT

The present disclosure provides techniques for recommending targeted information. One example method includes receiving user data indicative of one or more attributes of one or more users and activity data indicating past actions by the one or more users in association with particular content items, identifying, using a first machine learning model, a topic based on the activity data, identifying, using a second machine learning model, a subset of attributes of the one or more attributes of the one or more users that are associated with the topic, generating a prompt based on the topic and the subset of attributes associated with the topic, and generating, based on the prompt using a large language model (LLM), content to provide to a user having the subset of attributes associated with the topic.

### INTRODUCTION

Aspects of the present disclosure relate to recommending targeted information.

More and more users rely on recommendations to purchase goods or services. Recommendations are often generated based on the past interactions, such as the purchase history or interests, of the users. Such recommendations can help users discover products, content, or services better suited to the needs of the users, such as a product of better quality or a pair of products often used together (e.g., a cooler paired with ice packs).

However, existing recommender system techniques such as collaborative filtering and content-based filtering often encounter the cold start problem, requiring long hours to learn user preferences and extensive tuning of a model before recommending the most relevant and helpful information to the users, resulting in inefficiencies and inconveniences for the users.

Accordingly, improved systems and methods are needed for recommending targeted information.

### BRIEF SUMMARY

Certain embodiments provide a method for recommending targeted information.

The method generally includes receiving user data indicative of one or more attributes of one or more users and activity data indicating past actions by the one or more users in association with particular content items, identifying, using a first machine learning model, a topic based on the activity data, identifying, using a second machine learning model, a subset of attributes of the one or more attributes of the one or more users that are associated with the topic based on one or more of a score associated with the second machine learning model, a weight associated with an attribute of the one or more attributes in the second machine learning model, or a label associated with the topic, generating a prompt based on the topic and the subset of attributes associated with the topic, and generating, based on the prompt using a large language model (LLM), content to provide to a user having the subset of attributes associated with the topic.

Other embodiments provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of the various embodiments.

### BRIEF DESCRIPTION OF DRAWINGS

The appended figures depict certain features of the various aspects described herein and are not to be considered limiting of the scope of this disclosure.

FIG. 1 depicts an example recommender system for recommending targeted information.

FIG. 2 depicts an example process for prompt generation.

FIG. 3 is a flow diagram of example operations for recommending targeted information.

FIG. 4 depicts an example application server related to embodiments of the present disclosure.

### DETAILED DESCRIPTION

Aspects of the present disclosure provide apparatuses, methods, processing systems, and computer-readable mediums for recommending targeted information.

Users and consumers are presented with a wide range of information every day. However, the majority of the information has a relatively low level of relevance for the users as the information is not specifically targeted to (e.g., tailored to the needs of) the users.

Large language models (LLMs) are highly flexible and capable tools for natural language generation and manipulation, including creative writing, analysis, research, and interactive conversation. In particular, they can be used to generate information rich messages (e.g., the description of a product or a service) tailored to the needs of a user.

However, a carefully engineered prompt is necessary to successfully retrieve relevant information from the myriad of information encoded by the LLMs and generate targeted recommendations for the users.

User data denoting different groups of users (e.g., by age, income, location, etc.) and activity data indicating past interactions (e.g., liking, disliking, clicking, subscribing, making purchase, etc.) by the users towards content items are used to find what a particular group might be interested in or find most helpful in addressing their needs.

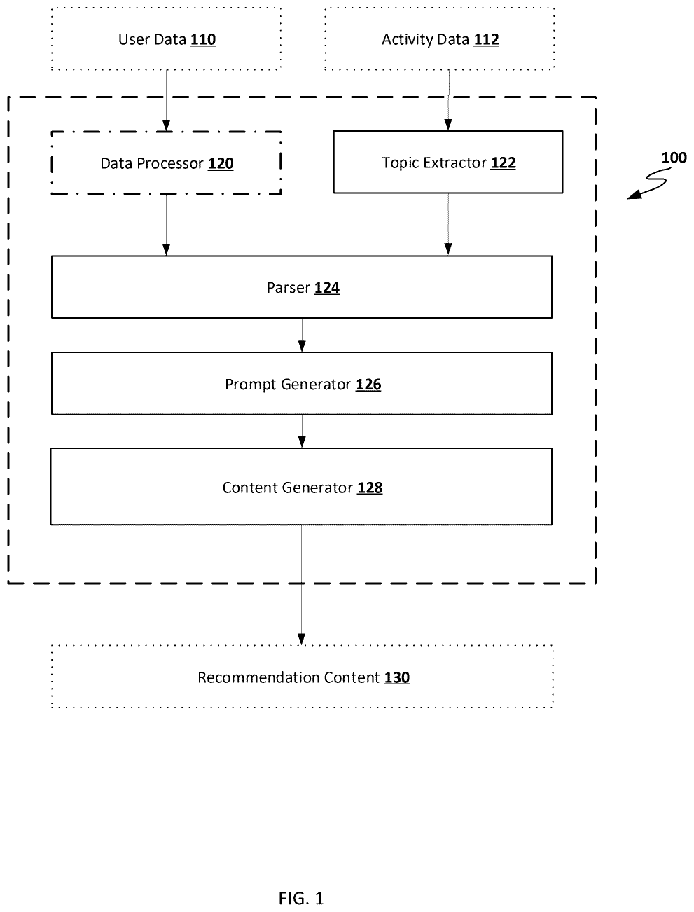

Given some user data may be imported from or exported to external source(s) (e.g., a distribution platform), there may be discrepancies between the group attributes collected by the external sources and the attributes used internally. User data can undergo data cleaning to ensure uniformity between external and internal data formats or designations. For example, attributes denoting similar concepts (e.g., “position” and “job_title”) can be combined (e.g., mapped to each other) whereas attributes collected internally but absent from the external source, or vice versa, may be excluded from downstream analysis. Details regarding the data cleaning can be found below with respect to FIG. 1.

Contents that the users interacted with often have one or more topics (e.g., travel, sports, food, etc.). These topics can be identified using a topic classification model, such as a latent Dirichlet allocation (LDA) model, a non-negative matrix factorization (NMF) model, a Top2Vec model, or a Bidirectional Encoder Representations from Transformers Topic (BERTopic) model. For each topic, a machine learning model can be used to find the attributes shared by a group of users who would find information related to the topic most helpful. The machine learning model can be trained using the user attributes as the inputs and the actions by the user regarding the topic as the label.

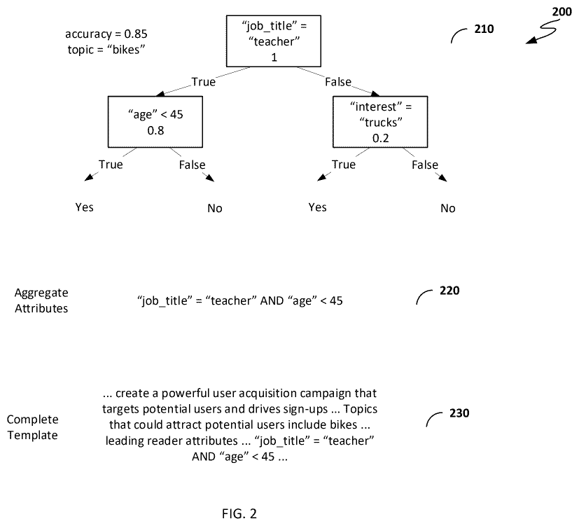

If the model has an accuracy score above a threshold, the model is considered as having a good fit with the data. Then the weight (e.g., a model weight or an explainability score) associated with an attribute in the model can be used to determine whether users with the attributes would find the information helpful. If an attribute has an accuracy score above a threshold, the attribute can be considered as relevant. Details regarding finding the subset of attributes for a particular topic can be found below with respect to FIGS. 1-2.

A prompt can be generated using the topics with associated attributes from a template prompt with placeholder topics and associated attributes. The placeholders can be filled in or replaced with the topics and associated attributes found earlier. The template prompt may be directed to a specific task, where each task may specify a predefined set of topics or user attributes. The prompt can then be provided to a large language model (LLM) to generate recommendation content to provide to a user with the attributes associated with the topics. Details regarding generating the prompt can be found below with respect to FIGS. 1-2.

By creating a carefully engineered prompt incorporating information regarding both the topics and the attributes of the targeted audience, techniques described herein overcome deficiencies in existing techniques for computer-based recommending of targeted information. For example, while existing techniques may not give highly relevant and helpful recommendations from the start, techniques described herein allow a computing application to give relevant and helpful recommendations from the start. On the other hand, finding associated attributes for each topic also helps providers of products or services better understand what users are interested in and target their intended audience better, minimizing resources to reach out to users unlikely to be interested and instead focusing on most interested users, thereby increasing efficiencies in transactions while reducing waste in precious time and computational resources. Thus, embodiments of the present disclosure provide a technical improvement with respect to conventional techniques for recommending targeted information.

### Example Recommender System for Recommending Targeted Information

FIG. 1 depicts an example recommender system 100 for recommending targeted information. Recommender system 100 can receive user data 110 and activity data 112 as inputs and generate recommendation content 130 as the output. Recommender system 100 can be deployed either online or offline.

User data 110 may indicate, for each user of one or more users, attributes of the user, such as a geographical location, an age group, an income level, and/or the like. In other words, user data 110 includes one or more categories assigned to each of the individual users. User data 110 can be represented using appropriate data structures, such as an array, a matrix, a dictionary, a nested list, and/or the like.

Additionally, activity data 112 may indicate, for each user, past actions (e.g., clicking, liking, disliking, sharing, wish listing, making a subsequent purchase, inactivity, etc.) by the user toward particular content items (e.g., promotional messages, descriptions of a product or a service, and/or the like). In other words, activity data 112 includes one or more content items and the reactions by each user towards the content items that the user encountered. Activity data 112 can be represented using appropriate data structures, such as an array, a matrix, a dictionary, a nested list, and/or the like.

In some examples, part of user data 110 is imported from or will be exported to an external source. An attribute in user data 110 may have different designations across internal and external sources, or may be present in one and absent in others. For example, an attribute designated as “job_level” in an internal source may be designated as “position” in external source A while absent in external source B.

To ensure uniformity of data formats of the attributes, user data 110 can be provided to data processor 120. Data processor 120 can first determine, for an attribute in user data 110, whether there is an exact match (e.g., sharing a predefined attribute designation) between the internal designation and the external designation. When there is a mismatch (e.g., an attribute does not have the predefined attribute designation), data processor 120 then uses one or more machine learning models (e.g., a sentence transformer, a transformer, or a Bidirectional Encoder Representations from Transformers (BERT) encoder) to convert the attribute into an encoding. If the encoding of the attribute meets a threshold (e.g., computed via cosine similarity) associated with an encoding of the predefined attribute designation, the predefined attribute designation is assigned to the attribute. Otherwise, the attribute is regarded as absent and may be excluded.

Following the example above, with “position” as the predefined attribute designation, the attribute “job_level” in the internal source does not have an exact match with attribute “position” in external source A. Then, data processor 120 can convert “job_level” into an encoding and check whether the encoding of “job_level” meets a threshold (e.g., a cosine similarity of 0.85 or more) with the encoding of “position”. If the threshold is met, data processor 120 then assigns “position” to attribute “job_level”, so as to replace “job_level” in user data 110 with “position”.

In another example, external source B does not have a corresponding attribute for attribute “job_level” in the internal source. Data processor 120 can try to find an attribute from external source B that would meet the threshold with the encoding of “job_level”. If no such attribute from external source B is found (e.g., no encoding of any attribute from external source B having a cosine similarity of 0.85 or more with the encoding of “job_level”), data processor 120 then excludes the attribute “job_level” from the user data 110.

Activity data 112 can be provided as inputs to topic extractor 122. Topic extractor 122 can use one or more machine learning models for topic classification, such as a latent Dirichlet allocation (LDA) model, a non-negative matrix factorization (NMF) model, a Top2Vec model, or a BERTopic model, to extract one or more topics associated with each content item in activity data 112. In an example, a content item describes cuisines at a restaurant in a foreign country and topic extractor 122 may extract from the content item one or more topics, such as “food”, “travel”, “cooking”, and so on.

The attributes of the users and the topics can then be provided to parser 124 to identify for each topic the associated attributes. Parser 124 can find, for each topic, a subset of the attributes associated with the topic. In some examples, each attribute in the subset may also indicate a specific attribute value. In other words, parser 124 may find, for a topic, associated attributes indicating specific attribute values shared by a group of users who may be most interested in the topic or find the topic most helpful (e.g., in meeting their needs).

For example, parser 124 may find, for topic “yoga”, associated attributes including “age_group”, “income_level”, “location”, while specifically “age group” has attribute value “young adult”, “income_level” has attribute value “middle_class”, and “location” has attribute value “suburban”. An attribute value can indicate a category or a range of numerical values (e.g., “age”<35).

Parser 124 can find the associated attributes for the topic using a machine learning model, such as a decision tree, a random forest, a boosted tree, a linear regression, a logistic regression, a support vector machine, or a neural network. For example, the machine learning model can be trained using the attributes of users as input features and a past action (e.g., regarding a click through rate, an amount of total purchases, or an average amount of purchases within a time period) associated with content items under the topic of the users as the label associated with the topic. The score associated with the machine learning model (e.g., an accuracy or a mean average precision (mAP)) can be used to evaluate the performance of the machine learning model. In other words, the score represents how good the fit is by the model. Details regarding inputs and labels for the machine learning model can be found with respect to FIG. 2.

If the score meets a threshold (e.g., an accuracy or mAP of 0.9), the subset of attributes are identified based on weights associated with the attributes. The weights can include a weight (e.g., in a simple model) or an explainability score (e.g., in a complex model) associated with a particular attribute in the machine learning model. For example, attributes with a weight meeting a threshold weight are included in the subset whereas attributes with a weight not meeting the threshold weight are not included in the subset. In some examples, parser 124 constructs a set of rules using the subset of attributes. Details regarding finding attributes associated with a topic can be found with respect to FIG. 2.

A topic and the associated attributes can be provided to prompt generator 126 to generate a prompt indicating the topic. Prompt generator 126 may retrieve a template prompt suited to a specific task (e.g., generating a description for a product) and combine the topic and the associated attributes (e.g., indicating specific attribute values) into the template prompt. In other words, prompt generator 126 may generate a prompt instructing a LLM to perform the specific task based on topic and the associated attributes. Details regarding generating a prompt can be found with respect to FIG. 2.

The prompt can then be provided to a content generator 128 to generate, based on the prompt, recommendation content 130 to present to a user having the attributes (e.g., indicating the specific attribute values) associated with the topic. Content generator 128 may generate recommendation content 130 using a large language model (LLM), such as a generative pre-trained transformer (GPT) model, a LLaMA model, or a Gemma model. The content generated can then be distributed to the user.

### Example Process for Prompt Generation

FIG. 2 depicts an example process 200 for prompt generation. Matching the attributes with the topic can be performed by a parser, such as parser 124 as shown in FIG. 1. The prompt can be generated by prompt generator 126 as shown in FIG. 1. Process 200 can be carried out by a recommender system, such as recommender system 100 as shown in FIG. 1.

Although FIG. 2 depicts a decision tree classifier used in a parser, the parser can use other machine learning classifiers or regressors, such as a decision tree regressor, a random forest, a boosted tree, a linear regression, a logistic regression, a support vector machine, or a neural network. Although the model in FIG. 2 indicates a score related to accuracy, the score can relate to other metrics, such as mAP as discussed with respect to FIG. 1.

Process 200 starts by receiving model weights 210. Model weights 210 may be from a machine learning model trained using attributes of users as inputs and information related to a particular topic as the label, as described with respect to FIG. 1. The attributes may be the same as or similar to attributes from user data 110 as shown in FIG. 1. The label may include information about a click through rate for the particular topic, an amount of total purchases under the topic or a mean amount of purchases under the topic within a given time window (e.g. for the past three months).

In this example, the machine learning model is a decision tree classifier. The decision tree classifier has an accuracy score of 0.85 for the topic “bikes” and is trained using attributes as inputs and an indicator function of a click through rate (e.g., 0.7) for the topic “bikes” as the label. The indicator function of the click through rate may indicate, for the particular topic, whether each user has met the click through rate, such as the binary indications (e.g., Yes and No) as depicted. Here “job_title”, “age”, and “interest” are attributes and “teacher”, “<45”, and “trucks” are the respective attribute values, as discussed with respect to FIG. 1.

In this example, model weights 210 include two levels with three decision nodes where each node also indicates a weight. For simplicity, the weights are regarded as model weights of the attributes in this example, though the weights can represent other parameters, such as the explainability score as discussed with respect to FIG. 1.

The start node with a weight of 1 checks whether a user has “teacher” as “job_title”. If the user does have “teacher” as “job_title”, the left node with a weight of 0.8 follows and checks whether the user has “age” less than 45. If so, the user is then determined to meet the click through rate for the topic “bikes”. If the user does not have “teacher” as “job_title”, the user is then determined not to meet the click through rate for the topic “bikes”.

If the user does not have “teacher” as “job_title”, the right node with a weight of 0.2 follows and checks whether the user has “trucks” as “interest”. If so, the user is then determined to meet the click through rate for the topic “bikes”. If the user does not have “trucks” as “interest”, the user is then determined not to meet the click through rate for the topic “bikes”.

In this example, the accuracy score (0.85) of the model meets a predefined threshold (e.g., 0.7), and the parser can proceed to find for the topic “bikes” relevant attributes that meet a threshold weight (e.g., 0.6). The attributes “job_title” with a weight of 1 and “age” with a weight of 0.8 meet the threshold weight and are included in a subset of attributes whereas the attribute “interest” with a weight of 0.2 does not meet the threshold weight and is not included in the subset of attributes.

Combined rule 220 is then generated to aggregate the subset of attributes for a particular topic. In this example, combined rule 220 indicates “job_title”=“teacher” AND “age”<45 for the topic “bikes”, where AND denotes the logical AND operator. In other examples, additionally, attributes also are combined using the logical OR operator.

Combined rule 220 can be used to generate prompt 230. Prompt 230 can be used as an input into a content generator to generate recommendation content, such as recommendation content 130 as shown in FIG. 1. Prompt can be generated based on a template, which may be directed to a specific task. In this example, the template is directed to a specific task to “create a powerful user acquisition campaign that targets potential users and drives sign-ups.”

An example template may read as the following:

Welcome, LLM! Our company is gearing up to launch ‘Calm Mind’—a powerful subscription-based meditation app that promotes mental wellness. We need you to create a powerful user acquisition campaign that targets potential users and drives sign-ups. Specifically, we want you to focus on extracting topics and attributes that are highly relevant to each user that has shown interest in ‘Calm Mind’. Topics that could attract potential users include {topic}, {topic}, and {topic}. Additionally, we want you to identify leading reader attributes that typically define a potential user. For example, we've found that ‘Calm Mind’ often attracts {reader attributes}. It's important to use this information to tailor the marketing message to each user's interests and needs. Therefore, please use the information provided to generate a compelling and engaging campaign acquisition text for ‘Calm Mind.’ Our goal is to appeal to each potential user's interests in mental wellness and meditation, and encourage them to sign up for ‘Calm Mind.’

To generate prompt 230, a prompt generator can specify the placeholder values (e.g., represented as {topic} and {reader attributes}) based on combined rule 220 for a topic or multiple topics. Additionally, combined rule 220 can be converted into a natural language representation. In this example, additionally, the prompt generator adds a header (e.g., specifying the name of the product) based on further requirements for the task.

### Example Operations for Recommending Targeted Information

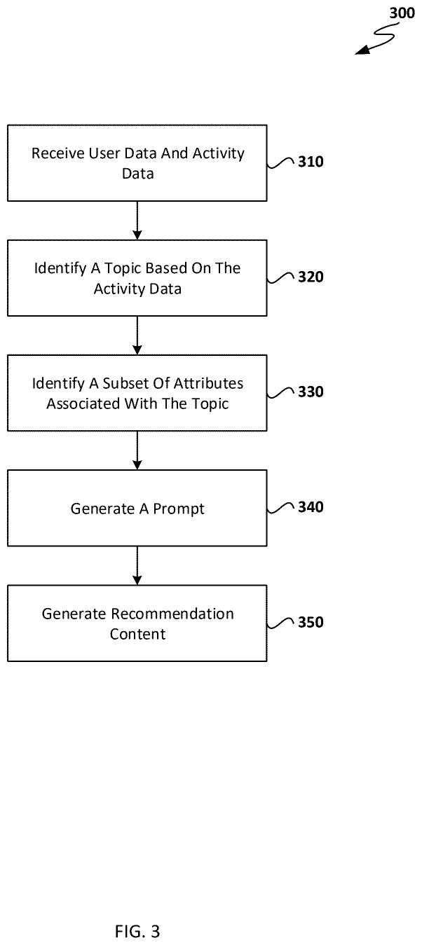

FIG. 3 is a flow diagram of example operations 300 for recommending targeted information. Operations 300 may be performed by a recommender system, such as recommender system 100 as illustrated in FIG. 1.

Operations 300 begin at 310, where user data indicative of one or more attributes of one or more users and activity data indicating past actions by the one or more users in association with particular content items are received. For example, the user data can be user data 110 and the activity data can be activity data 112 as illustrated in FIG. 1.

In some embodiments, when it is determined that an attribute in the one or more attributes of the one or more users does not have a predefined attribute designation, the attribute in the one or more attributes is converted into an encoding using a machine learning model. For example, the encoding can be generated by data processor 120 as illustrated in FIG. 1.

In such embodiments, the converting, using the third machine learning model, comprises using one or more of a sentence transformer, a transformer, or a Bidirectional Encoder Representations from Transformers (BERT) encoder.

If the encoding of the attribute meets a threshold associated with an encoding of the predefined attribute designation, a predefined attribute designation is assigned to the attribute in the one or more attributes. Otherwise, the attribute from the one or more attributes is excluded if the encoding of the attribute fails to meet the threshold associated with the encoding of the predefined attribute designation.

In such embodiments, determining the threshold associated with the predefined attribute designation is based on a cosine similarity with respect to the encoding of the predefined attribute designation.

At 320, a topic based on the activity data is identified using a first machine learning model. For example, the topic can be identified by topic extractor 122 as illustrated in FIG. 1. In some embodiments, the identifying, using the first machine learning model, comprises using a BERTopic model.

At 330, a subset of attributes of the one or more attributes of the one or more users that are associated with the topic is identified using a second machine learning model based on one or more of a score associated with the second machine learning model, a weight associated with an attribute of the one or more attributes in the second machine learning model, or a label associated with the topic. For example, the subset of attributes can be identified by parser 124 as illustrated in FIG. 1 or as discussed with respect to FIG. 2.

In some embodiments, the identifying, using the second machine learning model, comprises using one or more of a decision tree, a random forest, a boosted tree, a linear regression model, a logistic regression model, a support vector machine, or a neural network.

In some embodiments, the score is generated based on one or more of an accuracy or a mean average precision (mAP) of the second machine learning model, as as discussed with respect to FIGS. 1-2.

In some embodiments, the label associated with the topic includes one or more of a click through rate associated with the topic, an amount of total purchases under the topic, or a mean amount of purchases under the topic within a given time window, as discussed with respect to FIGS. 1-2.

At 340, a prompt is generated based on the topic and the subset of attributes associated with the topic. For example, the prompt can be prompt 230 as illustrated in FIG. 2 and can be generated by prompt generator 126 as illustrated in FIG. 1.

At 350, content is generated, based on the prompt using a large language model (LLM), to provide to a user having the subset of attributes associated with the topic. For example, the content can be recommendation content 130 generated by content generator 128 as illustrated in FIG. 1.

### Example Application Server

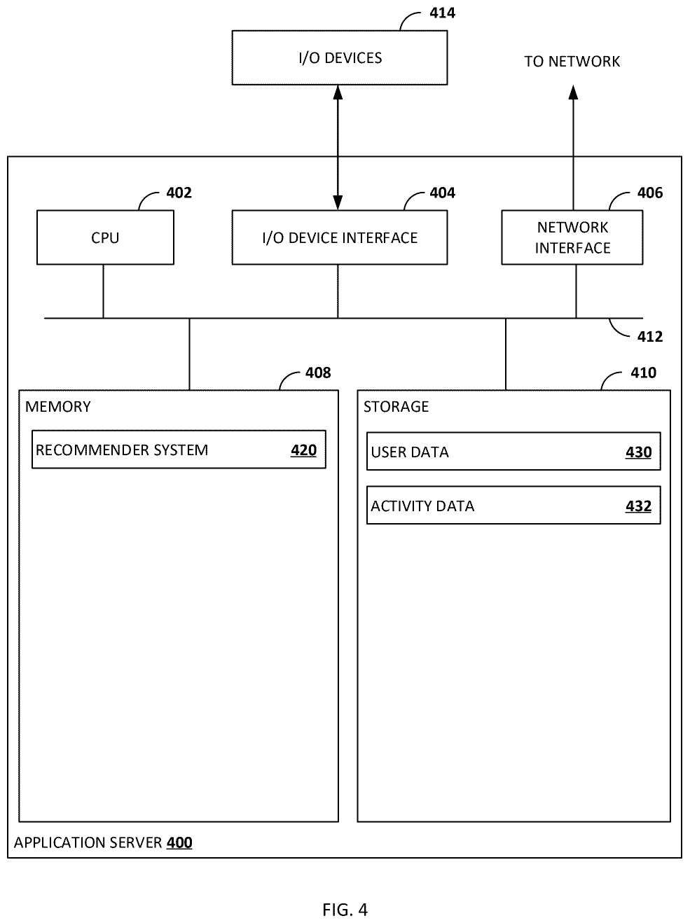

FIG. 4 depicts an example application server 400, which can be used to deploy recommender system 100 of FIG. 1. As shown, application server 400 includes a central processing unit (CPU) 402, one or more input/output (I/O) device interfaces 404, which may allow for the connection of various I/O devices 414 (e.g., keyboards, displays, mouse devices, pen input, etc.) to application server 400, a network interface 406, a memory 408, a storage 410, and an interconnect 412.

CPU 402 may retrieve and execute programming instructions stored in memory 408. Similarly, CPU 402 may retrieve and store application data residing in memory 408. Interconnect 412 transmits programming instructions and application data, among CPU 402, I/O device interface 404, network interface 406, memory 408, and storage 410. CPU 402 is included to be representative of a single CPU, multiple CPUs, a single CPU having multiple processing cores, and the like. I/O device interface 404 may provide an interface for capturing data from one or more input devices integrated into or connected to application server 400, such as keyboards, mice, touchscreens, and so on. Memory 408 may represent a random access memory (RAM), while storage 410 may be a solid state drive, for example. Although shown as a single unit, storage 410 may be a combination of fixed and/or removable storage devices, such as fixed drives, removable memory cards, network attached storage (NAS), or cloud-based storage.

As shown, memory 408 includes recommender system 420. Recommender system 420 may be the same as or substantially similar to recommender system 100 of FIG. 1.

As shown, storage 410 includes user data 430 and activity data 432. User data 430 may be the same as or substantially similar to user data 110 while activity data 432 may be the same as or substantially similar to activity data 112 of FIG. 1.

It is noted that the components depicted in application server 400 are included as examples, and other types of computing components may be used to implement techniques described herein. For example, while memory 408 and storage 410 are depicted separately, components depicted within memory 408 and storage 410 may be stored in the same storage device or different storage devices associated with one or more computing devices.

### Additional Considerations

The preceding description provides examples, and is not limiting of the scope, applicability, or embodiments set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The previous description is provided to enable any person skilled in the art to practice the various embodiments described herein. Various modifications to these embodiments will be readily apparent to those skilled in the art, and the generic principles defined herein may be applied to other embodiments. Thus, the claims are not intended to be limited to the embodiments shown herein, but are to be accorded the full scope consistent with the language of the claims.

Within a claim, reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112 (f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A processing system may be implemented with a bus architecture. The bus may include any number of interconnecting buses and bridges depending on the specific application of the processing system and the overall design constraints. The bus may link together various circuits including a processor, machine-readable media, and input/output devices, among others. A user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media, such as any medium that facilitates transfer of a computer program from one place to another. The processor may be responsible for managing the bus and general processing, including the execution of software modules stored on the computer-readable storage media. A computer-readable storage medium may be coupled to a processor such that the processor can read information from, and write information to, the storage medium. In the alternative, the storage medium may be integral to the processor. By way of example, the computer-readable media may include a transmission line, a carrier wave modulated by data, and/or a computer readable storage medium with instructions stored thereon separate from the wireless node, all of which may be accessed by the processor through the bus interface. Alternatively, or in addition, the computer-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module, it will be understood that such functionality is implemented by the processor when executing instructions from that software module.

What is claimed is:

1. A method, comprising:
receiving user data indicative of one or more attributes of one or more users and activity data indicating past actions by the one or more users in association with particular content items;
identifying, using a first machine learning model, a topic based on the activity data;
identifying, using a second machine learning model, a subset of attributes of the one or more attributes of the one or more users that are associated with the topic based on one or more of:
a score associated with the second machine learning model;
a weight associated with an attribute of the one or more attributes in the second machine learning model; or
a label associated with the topic;
generating a prompt based on the topic and the subset of attributes associated with the topic; and
generating, based on the prompt using a large language model (LLM), content to provide to a user having the subset of attributes associated with the topic.

2. The method of claim 1, further comprising:
determining that an attribute in the one or more attributes of the one or more users does not have a predefined attribute designation;
converting, using a third machine learning model, the attribute in the one or more attributes into an encoding; and
performing one of:
assigning a predefined attribute designation to the attribute in the one or more attributes based on the encoding of the attribute meeting a threshold associated with an encoding of the predefined attribute designation; or
excluding the attribute from the one or more attributes based on the encoding of the attribute failing to meet the threshold associated with the encoding of the predefined attribute designation.

3. The method of claim 2, wherein the converting, using the third machine learning model, comprises using one or more of a sentence transformer, a transformer, or a Bidirectional Encoder Representations from Transformers (BERT) encoder.

4. The method of claim 2, further comprising determining the threshold associated with the predefined attribute designation based on a cosine similarity with respect to the encoding of the predefined attribute designation.

5. The method of claim 1, wherein the identifying, using the first machine learning model, comprises using a BERTopic model.

6. The method of claim 1, wherein the identifying, using the second machine learning model, comprises using one or more of a decision tree, a random forest, a boosted tree, a linear regression, a logistic regression, a support vector machine, or a neural network.

7. The method of claim 1, wherein the score is generated based on one or more of an accuracy or a mean average precision (mAP) of the second machine learning model.

8. The method of claim 1, wherein the label associated with the topic includes information related to one or more of a click through rate associated with the topic, an amount of total purchases under the topic, or a mean amount of purchases under the topic within a given time window.

9. A system, comprising:
a memory including computer executable instructions; and
a processor configured to execute the computer executable instructions and cause the system to:
receive user data indicative of one or more attributes of one or more users and activity data indicating past actions by the one or more users in association with particular content items;
identify, using a first machine learning model, a topic based on the activity data;
identify, using a second machine learning model, a subset of attributes of the one or more attributes of the one or more users that are associated with the topic based on one or more of:
a score associated with the second machine learning model;
a weight associated with an attribute of the one or more attributes in the second machine learning model; or
a label associated with the topic;
generate a prompt based on the topic and the subset of attributes associated with the topic; and
generate, based on the prompt using a large language model (LLM), content to provide to a user having the subset of attributes associated with the topic.

10. The system of claim 9, wherein the processor is further configured to execute the computer executable instructions and cause the system to:
determine that an attribute in the one or more attributes of the one or more users does not have a predefined attribute designation;
convert, using a third machine learning model, the attribute in the one or more attributes into an encoding; and
performed one of:
assign a predefined attribute designation to the attribute in the one or more attributes based on the encoding of the attribute meeting a threshold associated with an encoding of the predefined attribute designation; or
exclude the attribute from the one or more attributes based on the encoding of the attribute failing to meet the threshold associated with the encoding of the predefined attribute designation.

11. The system of claim 10, wherein the converting, using the third machine learning model, comprises using one or more of a sentence transformer, a transformer, or a Bidirectional Encoder Representations from Transformers (BERT) encoder.

12. The system of claim 10, wherein the processor is further configured to execute the computer executable instructions and cause the system to determine the threshold associated with the predefined attribute designation based on a cosine similarity with respect to the encoding of the predefined attribute designation.

13. The system of claim 9, wherein the identifying, using the first machine learning model, comprises using a BERTopic model.

14. The system of claim 9, wherein the identifying, using the second machine learning model, comprises using one or more of a decision tree, a random forest, a boosted tree, a linear regression, a logistic regression, a support vector machine, or a neural network.

15. The system of claim 9, wherein the score is generated based on one or more of an accuracy or a mean average precision (mAP) of the second machine learning model.

16. The system of claim 9, wherein the label associated with the topic includes information related to one or more of a click through rate associated with the topic, an amount of total purchases under the topic, or a mean amount of purchases under the topic within a given time window.

17. A non-transitory computer readable medium comprising instructions to be executed in a computer system, wherein the instructions when executed in the computer system cause the computer system to:
receive user data indicative of one or more attributes of one or more users and activity data indicating past actions by the one or more users in association with particular content items;
identify, using a first machine learning model, a topic based on the activity data;
identify, using a second machine learning model, a subset of attributes of the one or more attributes of the one or more users that are associated with the topic based on one or more of:
a score associated with the second machine learning model;
a weight associated with an attribute of the one or more attributes in the second machine learning model; or
a label associated with the topic;
generate a prompt based on the topic and the subset of attributes associated with the topic; and
generate, based on the prompt using a large language model (LLM), content to provide to a user having the subset of attributes associated with the topic.

18. The non-transitory computer readable medium of claim 17, wherein the identifying, using the first machine learning model, comprises using a BERTopic model.

19. The non-transitory computer readable medium of claim 17, wherein the identifying, using the second machine learning model, comprises using one or more of a decision tree, a random forest, a boosted tree, a linear regression, a logistic regression, a support vector machine, or a neural network.

20. The non-transitory computer readable medium of claim 17, wherein the score is generated based on one or more of an accuracy or a mean average precision (mAP) of the second machine learning model.
